(19) United States
(12) Patent Application Publication
(10) Pub. No.: US 2026/0110351 A1
(43) Pub. Date: Apr. 23, 2026

(54) BALL SCREW ASSEMBLY AND METHODS FOR CONTROLLING THE SAME

(71) Applicant: University of Cincinnati, Cincinnati, OH (US)

(72) Inventors: Xu Han, Cincinnati, OH (US); Marcella Miller, Cincinnati, OH (US); Xiaodong Jia, Mason, OH (US); Gregory William Vogl, Gaithersburg, MD (US)

(21) Appl. No.: 19/361,403

(22) Filed: Oct. 17, 2025

Related U.S. Application Data
(60) Provisional application No. 63/708,344, filed on Oct. 17, 2024.

(51) Int. Cl. F16H 25/22; B23Q 5/40; F16H 25/20; G05B 15/02

(52) U.S. Cl. CPC F16H 25/2214; B23Q 5/402; F16H 25/2003; G05B 15/02; F16H 25/2015; F16H 2025/2075

(57) ABSTRACT

A ball screw assembly and methods for controlling the same in which the degradation of preload and/or development of backlash is monitored by calculating the axial natural frequency of the ball screw assembly are disclosed. The ball screw assembly includes a ball screw operatively coupled with a motor, and a ball screw nut mounted to the ball screw, such that rotation of the ball screw about an axis of rotation causes the ball screw nut to translate along the axis of rotation. Vibration of the ball screw nut during operation and coincident motor operational parameters are measured using corresponding vibration and motor sensors, and the resulting data is processed to determine an instantaneous natural frequency of the ball screw assembly. This instantaneous natural frequency value may then be compared against thresholds to trigger actions and/or correlated with a backlash value to influence operation of the ball screw assembly.

### CROSS REFERENCE TO RELATED APPLICATIONS

This application claims benefit to U.S. Provisional Application Ser. No. 63/708,344 filed Oct. 17, 2024, the entirety of which is incorporated herein by reference.

### STATEMENT REGARDING FEDERALLY SPONSORED RESEARCH AND DEVELOPMENT

This invention was made with government support under 60NANB21D114, awarded by the National Institute of Standards and Technology. The government has certain rights in the invention.

### TECHNICAL FIELD

The present disclosure relates to ball screw systems, and more particularly to methods and systems for monitoring the degradation of preload and/or development of backlash within ball screw assemblies.

### BACKGROUND

Ball screw systems are widely used in industrial machinery, CNC machine tools, robotics, and precision positioning applications. Compared to traditional lead screws or hydraulic actuators, ball screws offer improved positioning accuracy, minimal backlash, higher load capacities, and reduced friction, making them the preferred choice for applications requiring repeatable positioning within tight tolerances. Ball screw systems have become important components in modern automated manufacturing environments, and they can be found in assembly lines for semiconductors, medical devices, aerospace, and more.

### SUMMARY

In one aspect, a ball screw assembly including a ball screw that is operatively coupled to a motor and a ball screw nut mounted on the ball screw, such that rotation of the ball screw about an axis of rotation causes the ball screw nut to translate longitudinally along the axis of rotation. The ball screw assembly further includes a vibration sensor configured to measure vibration of the ball screw nut and a motor sensor configured to measure at least one of a motor speed, a motor torque, and/or a current draw of the motor.

In another aspect, a method for controlling a ball screw assembly, the method including steps of receiving vibration data measured by a vibration sensor that measures vibration of a ball screw nut mounted to a ball screw of a ball screw assembly, receiving motor data measured by a motor sensor that evaluates a motor which is operatively coupled to the ball screw, and determining an instantaneous axial natural frequency of the ball screw assembly based on the vibration data and the motor data. The motor data may include at least one of a motor speed, torque, and current draw.

In one aspect, a controller comprising at least one processor and a non-transitory computer-readable storage medium containing instructions that, when executed by the at least one processor, cause the controller to execute a method for controlling a ball screw assembly. The method includes steps of receiving vibration data measured by a vibration sensor that measures vibration of a ball screw nut mounted to a ball screw of a ball screw assembly, receiving motor data measured by a motor sensor that evaluates a motor which is operatively coupled to the ball screw, and determining an instantaneous axial natural frequency of the ball screw assembly based on the vibration data and the motor data. The motor data may include at least one of a motor speed, torque, and current draw.

These and additional features provided by the aspects described herein will be more fully understood in view of the following detailed description, in conjunction with the drawings.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, where like structure is indicated with like reference numerals and in which:

FIG. 1 schematically depicts an illustrative ball screw assembly, as described and illustrated herein;

FIG. 2A schematically depicts an illustrative raceway and balls of a ball screw assembly in which the balls have not undergone significant wear, as described and illustrated herein;

FIG. 2B schematically depicts an illustrative raceway and balls of a ball screw assembly in which the balls have undergone significant wear, as described and illustrated herein;

FIG. 3 schematically depicts an illustrative ball screw assembly and instrumentation, as described and illustrated herein;

FIG. 4 depicts an illustrative method for determining an axial natural frequency of a ball screw assembly, as described and illustrated herein;

FIG. 5 depicts an illustrative diagram for determining backlash of a ball screw assembly, as described and illustrated herein;

FIG. 6 depicts an illustrative graph charting the backlash and axial natural frequency of a ball screw assembly against operational time, as described and illustrated herein; and

FIG. 7 depicts an illustrative method for monitoring the wear of a ball screw assembly, as described and illustrated herein.

### DETAILED DESCRIPTION

Aspects described herein pertain to ball screw assemblies, systems having the same, and methods and corresponding instrumentation for monitoring the vibratory frequencies thereof to identify loss of preload within the ball screw assembly, which has been found to correlate with an increase in backlash and corresponding loss of precision of the ball screw assembly.

Despite their robust design, ball screws are subject to degradation over time due to factors such as wear, contamination, loss of lubrication, and/or cyclic loading, among others. The unexpected failure of a ball screw can result in costly unplanned downtime, damage to workpieces, and/or higher defect rates or an increase in quality control issues. Traditional maintenance approaches typically rely on time-based or cycle-based replacement schedules that can result in replacing adequately performing units earlier than necessary, driving up equipment costs. In contrast, reactive maintenance ensures that the life of the equipment is fully utilized but also results in production disruptions.

It is worth noting that “failure” here does not necessarily mean that the ball screw assembly has broken or become inoperably damaged. Rather, and especially in view of those high-precision applications in which ball screw assemblies are commonly used mentioned above, failure of a ball screw assembly can simply mean that the ball screw assembly is unable operate within specification(s) or within a predefined tolerance range. This loss in precision is often difficult to efficiently quantify using conventional means, as many of the affected components (e.g., the loss of preload in the balls) cannot be directly observed or measured during operation.

Accordingly, there exists a need for systems and methods that can continuously monitor the condition of ball screw assemblies and provide early warning of degradation, thereby enabling predictive maintenance strategies that can reduce downtime without prematurely retiring performant components.

As used herein, the term “backlash” refers to the amount of lost motion or clearance between mating components when the direction of movement is reversed. In ball screw systems, backlash manifests as a small gap or play between balls of the ball screw and the screw thread, or raceway, that results in a delay or position error when reversing directions. This gap or play permits the screw to rotate slightly before re-engaging and translating the nut, compromising positioning accuracy and repeatability. While backlash can be the result of manufacturing defects or inadequacies, backlash can also form within a ball screw assembly via the wearing of components over time or via an inadequate preload.

As used herein, the term “preload” refers to the intentional application of an axial force or interference fit within a ball screw assembly to eliminate internal clearances and minimize backlash. By compressing the bearings against the screw thread and/or raceways, preload ensures continuous contact between components regardless of the direction of motion. Preload may be achieved through various methods, including double-nut configurations, oversized balls, spring-loaded mechanisms, and/or the like, without limit.

As used herein, the phrase “communicatively coupled” refers to the interconnectivity of various components for the purposes of transmitting and/or receiving signals, transmitting and/or receiving data, and/or the like, independent of the medium (e.g., wired, wireless, near field, and/or the like, without limit) used to establish such a connection.

As used herein, “top,” “bottom”, “up,” and “down” refer to directions relative to gravity and a corresponding height direction of the ball screw system and/or ball screw assembly.

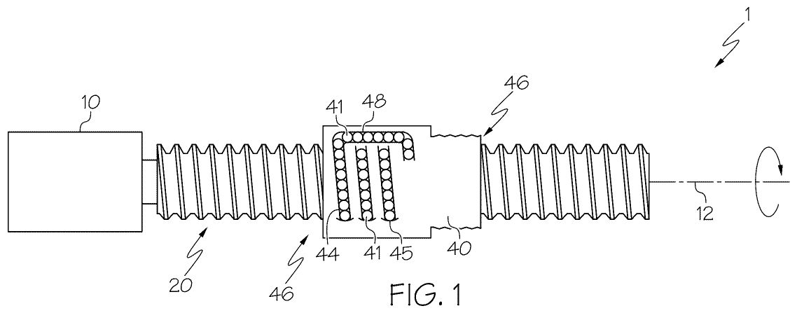

Turning now to FIG. 1, an exemplary ball screw assembly 1 according to aspects of the present disclosure is shown. The ball screw assembly 1 includes a ball screw 20 that is operatively connected (e.g., fixedly and/or detachably) to a motor assembly 10 that is configured to drive the ball screw 20 to rotate in any of a first direction and a second direction about an axis of rotation 12. In some aspects, the ball screw 20 may have a longitudinal axis that is coincident with the axis of rotation 12. The ball screw 20 may be provided with one or more raceways 22, or starts, that helically extend around an outer surface of the ball screw 20 at a predetermined lead and/or at a predetermined pitch. In some aspects, the lead and/or pitch may be such that the threads of a given raceway 22 are adjacent to one another as they helically extend along the ball screw 20. In some aspects, the lead and/or pitch may be such that the threads of a given raceway 22 are spaced apart from one another by a nonzero distance as they helically extend along the ball screw 20. In some aspects, this nonzero distance may include threaded portions of other raceways 22, or starts, also provided on the ball screw 20. In some aspects, this nonzero distance may include an unthreaded span at the major diameter of the ball screw 20.

Provided on the ball screw 20 may be a ball screw nut 40. The ball screw nut 40 secures against the body of the ball screw 20 a plurality of balls 41 that are disposed both within the one or more raceways 22 of the ball screw 20 and within corresponding nut raceways 44 of the ball screw nut 40. While the ball screw assembly 1 of FIG. 1 shows a ball screw nut having a single ball return channel 48, it is contemplated that the ball screw nut 40 may have any number of ball return channels 48 that each connect a starting portion of a given nut raceway 44 with an ending portion of the given nut raceway 44, such that the balls 41 contained therein may circulate about the ball nut 40 as the ball screw 20 is caused to rotate by the motor 10. The ball screw nut 40 may also include one or more end caps 46 to contain the balls 41 within the ball screw nut 40 and/or one or more wipers and/or seals provided to prevent contaminant ingress into the ball screw nut 40 and/or to retain lubrication within the ball screw nut 40. In some aspects, the ball screw nut 40 may include a preload mechanism having any number of spacers, springs, secondary sections, and/or the like provided for the purposes of reducing and/or eliminating backlash.

When the ball screw 20 is caused to rotate about the axis of rotation 12, the one or more raceways 22 of the ball screw 20 engage the balls 41 disposed within the corresponding nut raceways 44 of the ball screw nut 40. Due to the helical geometry of the thread path, rotation of the ball screw 20 in this manner causes the balls 41 to progress along the helical raceway in a direction that has both rotational and axial components relative to the axis of rotation 12. Because the balls 41 are captured between the ball screw 20 and the ball screw nut 40, and when the ball screw nut 40 is prevented from rotating, the axial component of the motion of the balls 41 translates the ball screw nut 40 linearly along the length of the ball screw 20.

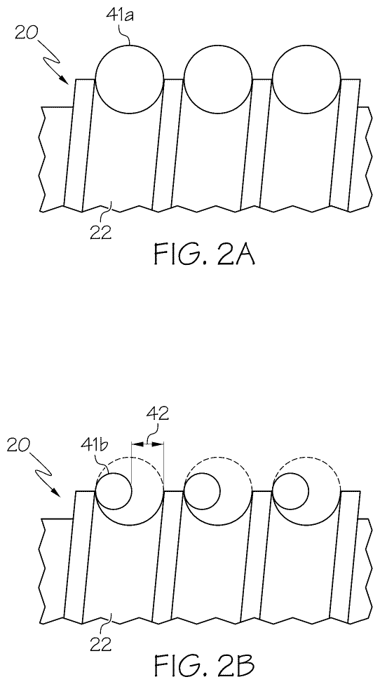

Turning now to FIG. 2A, with continued reference to FIG. 1, emphasized portions of the ball screw 20 and balls 41 are shown. FIG. 2A illustrates a ball screw assembly 1 without backlash. Here, the balls 41a that are provided between the ball screw 20 and the ball screw nut 40 (not shown) are sized to precisely fit the raceway 22 and/or sized to be slightly larger than the raceway 22 (i.e., are preloaded) such that there is a compressive force, or preload force, acting upon the balls 41a by the walls of the raceway 22 and/or the ball screw nut 40.

In the industry, preload is typically referenced as a fraction or percentage of the dynamic load rating of the ball screw assembly 1, or the load capacity at which the ball screw assembly 1 will theoretically achieve one million revolutions of rated life. In one non-limiting example, a preload of 3% on a 20,000 N rated ball screw would equate to 600 N of preload force. In some aspects, the balls 41a may be subject to a preload within a range of 1% to 15%, inclusive. In some aspects, the balls 41a may be subject to a preload of 4%. While the example of FIG. 2A achieves preloading by way of oversized balls 41a within the raceway 22, further to those discussions above, preload may be achieved with other mechanisms such as springs, spacers, and/or the like, without limit and without departing for the disclosure herein.

Turning now to FIG. 2B, with continued reference to FIGS. 1 and 2A, emphasized portions of a ball screw 20 and balls 41 are shown. FIG. 2B illustrates a ball screw assembly 1 having backlash 42. Here, whether due to manufacturing defects, manufacturing tolerances, and/or wear of the ball screw assembly 1, the balls 41b of the ball screw assembly 1 no longer adequately fit within the raceway 22 of the ball screw 20, such that a gap 42, or backlash, exists between the ball 41b and the thread walls of the raceway 22. When undergoing a reversal in direction, the balls 41b may traverse this gap 42 without fully engaging with the raceway 22, resulting in a rotation of the ball screw 20 that does not result in corresponding linear motion of the ball screw nut 40—at least until the balls 41b have traversed the gap 42 and contact the other side of the raceway 22.

This “dead space” in which the ball screw 20 is rotating but the ball screw nut 40 is not translating leads to precision losses, as many devices that make use of ball screw assemblies 1 calculate the linear position of the ball screw nut 40 based on rotational encoder measurements at the motor 10 rather than from direct measurement of the actual ball screw nut 40 position. As a result, whenever rotation of the ball screw 20 does not result in translation of the ball screw nut 40, the calculated position of the ball screw nut 40 deviates from the actual position of the ball screw nut 40.

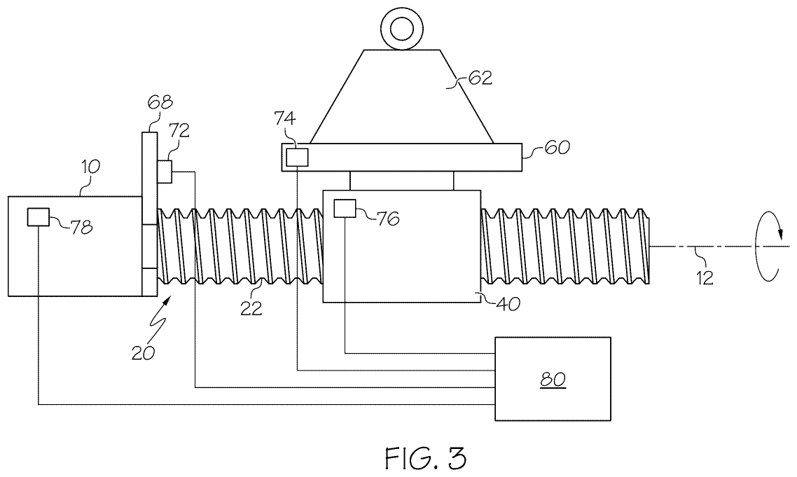

Turning now to FIG. 3, with continued reference to FIG. 1, aspects of a ball screw assembly 1 and a scheme for monitoring degradation of the same are shown. Here, again, a ball screw 20 provided with one or more raceways 22 is shown coupled to a motor 10 (e.g., servo motor, stepper motor, DC or AC, brushed or brushless, induction, direct drive, and/or the like, without limit) that may be operated to drive the ball screw 20 to rotate in a first direction and/or in a second direction about an axis of rotation 12. A ball screw nut 40, further to those descriptions above, is coupled to the ball screw 20. In some aspects, the ball screw nut 40 is restricted from rotating about the axis of rotation 12, such that a rotation of the ball screw 20 corresponds to a linear translation of the ball screw nut, further to those descriptions above.

A carriage 60 is shown coupled (e.g., fixedly and/or detachably) to the ball screw nut 40 such that translation of the ball screw nut 40 also results in translation of the carriage 60. Supported upon and/or at the carriage 60 is a load 62, which may include any of various types of payloads depending on the application. In some aspects, load 62 may include tooling (e.g., cutting tools, end effectors, grippers, inspection and/or sensing equipment, machining heads, and/or the like, without limit) that is positioned using the ball screw assembly 1. In some aspects, the load 62 may include workpieces, cargo, and/or the like being positioned and/or transported via the ball screw assembly 1.

In any case, the ball screw assembly 1 may be provided with one or more sensors 72, 74, 76, 78 for monitoring the performative characteristics of the ball screw assembly 1. In some aspects, the one or more sensors 72, 74, 76, 78 may be provided mounted to, on, and/or in any of the carriage 60 (e.g., sensor 74) and/or the ball screw nut 40 (e.g., sensor 76). In some aspects, sensors 74, 76 are provided to monitor vibrational characteristics of the ball screw nut 40 during operation of the ball screw assembly 1. In some aspects, sensors 74, 76 may include any of accelerometers (single and/or multi-axis), velocity sensors, microphones and/or acoustic emission sensors, laser microphones, force sensors, and/or the like, without limit. In some aspects, sensors 74, 76 may be provided near to and/or within line of sight to the ball screw nut 40 and/or the carriage 60 such that the vibrational characteristics may be measured at a distance.

Optionally, some aspects may include a fixture 68 mounted to and/or near the motor 10 and to which one or more sensors 72 may be affixed for the purposes of monitoring a linear position of the carriage 60. In some aspects, sensor(s) 72 may include any of capacitive displacement sensors, laser displacement sensors, linear encoders, hall effect sensors, cameras, and/or the like, without limit, that are configured to and/or capable of monitoring a position of the ball screw nut 40 and/or carriage 60.

In some aspects, the motor 10 may be provided with one or more sensors 78 for monitoring any of speed, torque, current draw, voltages, and/or the like of the motor 10 during operation of the ball screw assembly 1, without limit. The one or more sensors 78 may include any of rotary encoders, tachometers, resolvers, hall effect sensors, inductive sensors, transducers, reaction sensors, current sensors, voltage sensors, and/or the like, without limit. The speed, torque, current draw, voltages, and/or the like of the motor 10 may be measured and/or calculated directly and/or may be determined indirectly and/or via proxy, such as by monitoring back electromotive forces, motor frequencies, and/or the like to derive the desired components of the operation of the motor 10.

In some aspects, a controller 80 is provided for receiving telemetry data from the one or more sensors 72, 74, 76, 78 and/or for controlling operation of the motor 10 (i.e., directly or via a speed controller or stepper drive) to operate the ball screw assembly 1 to translate, convey, and/or otherwise position the load 62 at a predetermined position. Controller 80 may include one or more processors (e.g., central processing units, graphical processing units, neural processing units, AI processors, application-specific integrated circuits, field-programmable gate arrays, and/or the like, without limit), memory units (e.g., non-transitory volatile storage), storage units (e.g., non-transitory persistent and/or non-volatile storage), and/or interfaces (e.g., user interface, data interface, network interface, display, touchscreen, keyboard and/or keypad, wireless interface and/or radio, and/or the like, without limit). Controller 80 may further include stored within any of the memory and/or storage units computer code, instructions, software, or the like that, when executed by the one or more processors, cause the one or more processors and/or the controller 80 to carry out any of the methods, processes, and the like, or any number or combination of subparts thereof, described herein.

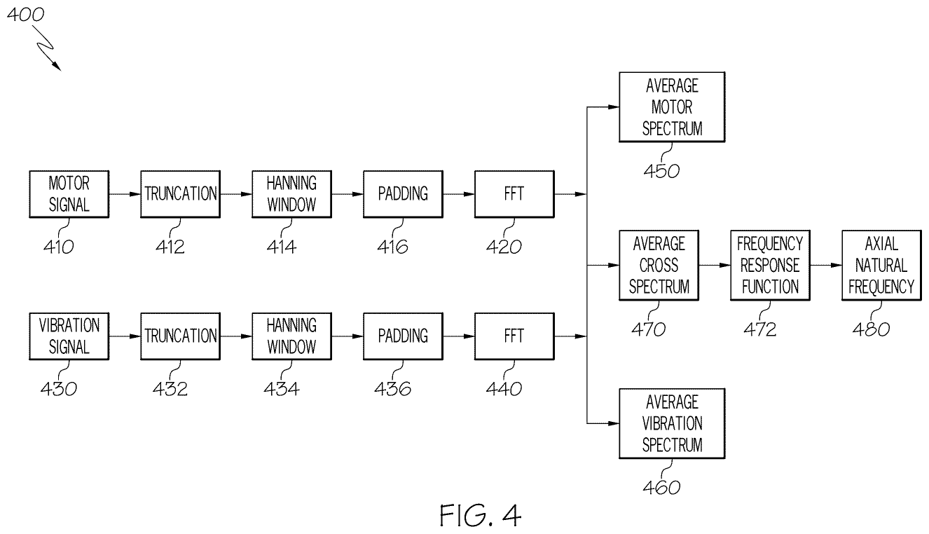

Turning now to FIG. 4, with continued reference to FIGS. 1 and 3, an exemplary method 400 for determining an axial natural frequency of a ball screw assembly further to the above is disclosed.

The preload P of the ball screw assembly 1 can be described as a function of the carriage 60 mass mₜ, axis position xₜ, first axial natural frequency fₐ of the ball screw 20, and some mechanical parameters Θ as seen in Equation (1), where Θ may include the basic dynamic load rating, transmission ratio, stiffness parameter, dimensions, material properties of the ball screw depending on the different manufacturer and ball screw type.

$$P = f ( {m}_{t} , {x}_{t} , {f}_{a} , Θ ) \qquad ( 1 )$$

Through some derivation from Equation (1), the axial natural frequency fₐ can be estimated as a function of the axis position xₜ, the preload P, and the carriage 60 mass mₜ, as seen in Equation (2). Based on the resulting relationship, the axial natural frequency decreases as the preload decreases and as the mass and position of the carriage 60 increase.

$${f}_{a} = g ( {x}_{t} , P , {m}_{t} , Θ ) \qquad ( 2 )$$

However, due to practical limitations, it is difficult to directly measure the preload P of the ball screw assembly 1. Instead, the axial natural frequency of the ball screw 20 may be identified by evaluating the frequency response function of the ball screw assembly 1 during operation by way of the one or more sensors 72, 74, 78.

In a step 410, motor data (e.g., torque, speed, current draw, and/or the like) is collected from one or more sensors 78 monitoring the motor 10 driving the ball screw 20. More specifically, the motor data is collected during one or more acceleration and/or deceleration operations, or transient operations, of the ball screw assembly 1. In some aspects, the motor data may, optionally, be truncated in a step 412 to eliminate irrelevant data and/or data from non-transient operational periods. In some aspects, the motor data may, optionally, be processed with a Hanning window in a step 414 to minimize spectral leakages. In some aspects, the motor data may, optionally, be subject to zero padding in a step 416 to smooth the resulting curves. Next, in a step 420, the motor data, modified or not further to the above, may be processed using a fast Fourier transform (FFT) to obtain the frequency domain and/or spectrum of the motor data.

In a step 430, vibration data is collected from one or more sensors 74, 76 monitoring one or both of the ball screw nut 40 and carriage 60. Similar to the above, vibration data is collected during one or more acceleration and/or deceleration operations, or transient operations, of the ball screw assembly 1. In some aspects, the vibration data may, optionally, be truncated in a step 432 to eliminate irrelevant data and/or data from non-transient operational periods. In some aspects, the vibration data may, optionally, be processed with a Hanning window in a step 434 to minimize spectral leakages. In some aspects, the vibration data may, optionally, be subject to zero padding in a step 436 to smooth the resulting curves. Next, in a step 440, the torque and/or speed data, modified or not further to the above, may be processed using an FFT to obtain the frequency domain and/or spectrum of the vibration data.

Following steps 420 and 440, the average motor spectrum 450 (FFT of force) and the average vibration spectrum 460 (FFT of acceleration) are known. The two spectra may then be combined in a step 470 to form an average cross spectrum from which a frequency response function (FRF) may be calculated in a step 472. Once the FRF is obtained, the axial natural frequency may be identified from the FRF in a step 480 by identifying the axial natural frequency as the predominant peak within the FRF data through any suitable means.

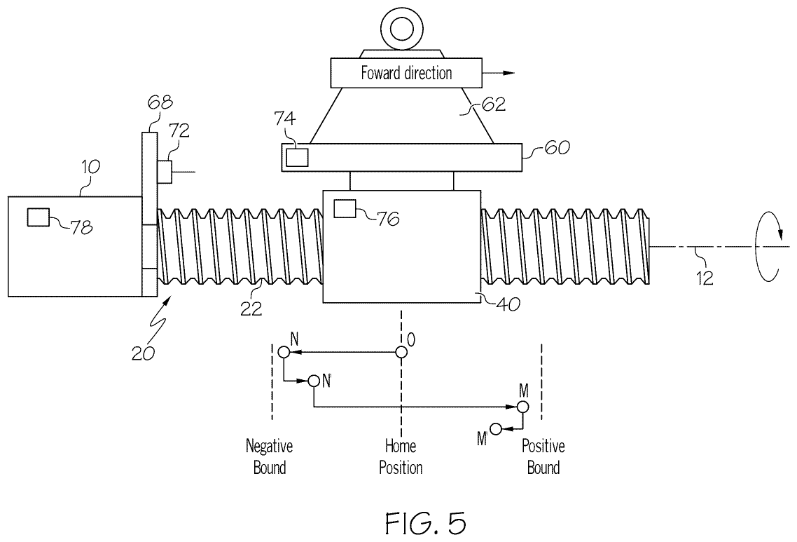

Turning now to FIG. 5, with continued reference to FIGS. 1 and 3-4, an illustrative diagram for obtaining backlash data points as measured by and/or determined from positional data obtained by the one or more distance sensors 72 and/or as measured at various points during the life of a given ball screw assembly 1 are charted alongside a backlash data fit curve 522 that fits the backlash data points 524. In some aspects, a path error measurement model may be used to obtain the backlash measurements. The ball screw assembly 1 may be commanded to move the ball screw nut 40 between a positive bound and a negative bound, which may be symmetrically distributed about a home position. The positive and negative bounds may be established in accordance with the specifications of the capacitive sensor 72. As illustrated in FIG. 5, the set point at the positive bound may be referred to as M, and the set point at the negative bound may be referred to as N. When backlash is present in the measured ball screw assembly 1, the commanded set points M and N may deviate from their respective bounds due to backlash error. In addition, two auxiliary points, M′ and N′, are introduced in proximity to M and N to characterize possible minor bounce-induced positional deviations and to represent the actual positions at which the measurements are taken. The ball screw assembly 1 is controlled to periodically move the ball screw nut 40 between the set positions as described. The measurement procedure can be repeated multiple times and then averaged to find the backlash b according to Equation (3):

$$b = ( M - N ) - ( {M}^{′} - {N}^{′} ) \qquad ( 3 )$$

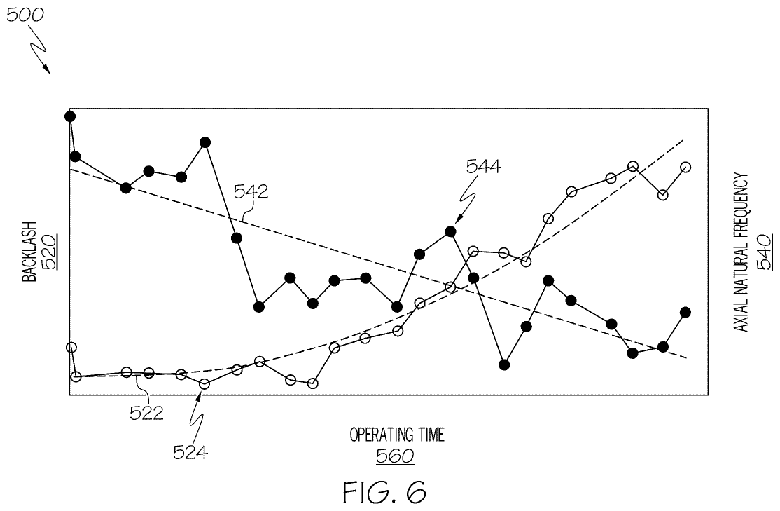

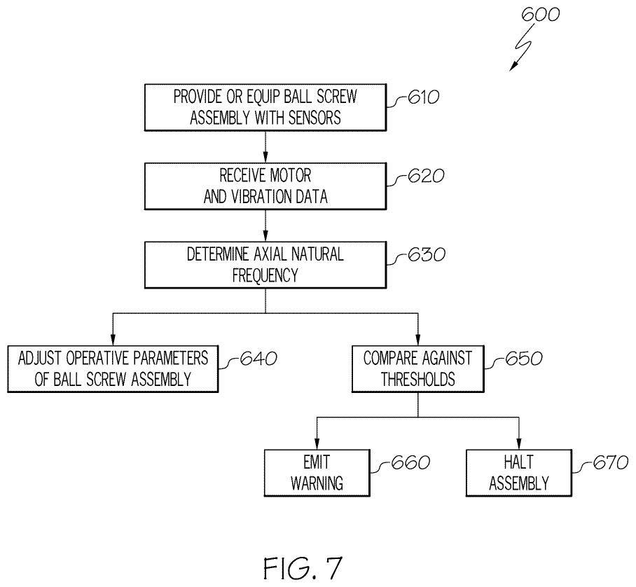

Turning now to FIG. 6, with continued reference to FIGS. 1 and 3-5, an exemplary graph 500 of backlash 520 and axial natural frequency 540 are plotted against an operational time 560 or total life operational duration of the ball screw assembly 1 is shown. Data of this sort may be obtained by instrumenting a ball screw assembly 1 with one or more sensors 72, 74, 76, and/or 78 and a known load 62 and then operating the ball screw assembly 1 for an extended period of time to repeatedly position the load 62 at and/or remove the load 62 from a predetermined axial position xₜ. In some aspects, the load 62 may be passed in a forwards and/or backwards direction, along the longitudinal axis of the ball screw 20, across a predetermined axial position xₜ. Measurement data—including vibrational data measured by sensors 74, 76; motor torque and/or speed data measured by sensor 78, and positional data measured by sensor 72—may be taken as the load 62 is brought to and/or removed from the predetermined axial position xₜ and logged against an operational time and/or duration of the ball screw assembly 1. The process may be repeated until the ball screw assembly 1 fails and/or falls out of specification.

Here, empirically obtained backlash data points 524, as measured by and/or determined from positional data obtained by the one or more distance sensors 72 and/or as measured at various points during the life of a given ball screw assembly 1 further to the above, are charted alongside a backlash data fit curve 522 that fits the backlash data points 524. As can be seen from the data points 524 and curve 522, backlash generally increases with increasing operational time of the ball screw assembly 1, or as the ball screw assembly operates for longer periods of time. This increase in backlash is generally associated with loss of preload, wear of components, cycle fatigue, and other similar life- and/or wear-related factors of the ball screw assembly 1.

Also shown here are empirically obtained axial natural frequency data points 544, as calculated further to the foregoing at various points during the life of the given ball screw assembly 1, charted alongside an axial natural frequency data fit curve 542 that fits the axial natural frequency data points 544. As can be seen from the data points 544 and curve 542, axial natural frequency generally decreases with increasing operational time of the ball screw assembly 1, or as the ball screw assembly operates for longer periods of time.

This finding is significant because it indicates that the degradation of the axial natural frequency of the ball screw assembly 1 over time may be used as a proxy for evaluating and/or estimating backlash. For ball screw assemblies 1 in particular, and systems containing the same generally, measuring backlash directly can be cost prohibitive. Ball screw assemblies 1 already typically operate at high precisions and/or within tight tolerances, and so while small amounts of backlash may significantly impact the performance of the ball screw assembly 1 and/or the ability of the ball screw assembly 1 to operate within specifications, this amount of backlash is, in an absolute sense, incredibly small. As a result, positional sensors 72, such as those capacitive sensors used in deriving the empirical data referenced above, must have a high sensitivity and/or a high precision in order to detect those amounts of backlash that may be operationally significant to the ball screw assembly 1. As is further evident from chart 500, the development of backlash 520 tends to follow an exponential curve, such that even greater precision may be required to resolve the early development of backlash in the ball screw assembly 1, lest backlash only be detected when the backlash is further developed, when failure is imminent or present, and/or the like. In general, sensors of this degree of sensitivity tend to be expensive and typically require frequent calibration and other maintenance to remain accurate. In some applications, it may be difficult or even impossible to adequately position such a positional sensor 72 to obtain the necessary measurements and/or to reach the sensor 72 for servicing, and/or such sensors may not be able to properly function within the environment in which the ball screw assembly 1 is intended to operate. Still, in those aspects in which provision of sensor 72 is feasible and/or accessible, backlash may be calculated further to the path error measurement methods discussed above. The use of a capacitive sensor in particular may overcome many of those difficulties present when using traditional sensing means.

In contrast, the provision of one or more accelerometers or other sensors 74, 76 on and/or in the ball screw nut 40 and/or the carriage 60 to monitor for vibration data that, with corresponding motor data from a motor sensor 78, can be used to calculate axial natural frequencies may be done more cheaply and/or more robustly. The data pre-processing steps outlined above may serve to further reduce the sensitivity required of the accelerometers or other sensors 74, 76, further reducing the costs and/or need to service and/or calibrate the sensors 74, 76. Multiple accelerometers, vibration sensors, and/or the like 74, 76 may also be easily provided and used, enabling redundancy and confirmation to those measurements obtained without significant cost or maintenance requirements.

Accordingly, the axial natural frequency of the ball screw assembly 1 may be determined, monitored, and/or used to influence operation of the ball screw assembly 1 and/or a system containing the same. In some aspects, the axial natural frequency may be determined periodically and/or according to a predetermined schedule. In some aspects, determination of the axial natural frequency is conducted as part of a “warmup,” “initialization,” and/or “homing” process of the ball screw assembly 1 and/or the system utilizing the same. In some aspects, the determined axial natural frequency is logged so that the progression of frequencies across the life of the ball screw assembly 1 may be tracked and/or used as part of evaluating thresholds. In some aspects, the determined axial natural frequency may not be persistently stored.

In any case, one or more predetermined thresholds may be established, the reaching and/or crossing of which may serve as a trigger for some responsive action (e.g., warning an operator that the ball screw assembly is approaching failure and/or has failed, halting operation of the ball screw assembly 1 and/or system containing the same, and/or the like, without limit).

In some aspects, the predetermined threshold is one or more predetermined setpoint frequencies, such that, when the determined axial natural frequency reaches, crosses, and/or falls below each setpoint frequency, an action (e.g., warning, halt signal, and/or the like) is correspondingly triggered. In some aspects, such setpoint frequencies are determined by empirically evaluating a model or representative ball screw assembly 1. In some aspects, such setpoint frequencies are determined theoretically further to the above. In some aspects, the setpoint frequency is an absolute frequency. In some aspects, the setpoint frequency is a relative frequency, such as a percentage (e.g., 95 percent, 90 percent, 80 percent, and/or the like, without limit) of a determined axial natural frequency of a “new” representative ball screw assembly and/or a determined axial natural frequency of the given ball screw assembly 1 when the assembly 1 was “new” or recently installed.

In some aspects, the predetermined threshold is a rate of change of the determined axial natural frequency and/or a gradient of the axial natural frequency over some portion of the life of the ball screw assembly 1.

Turning now to FIG. 6, with continued reference to FIGS. 1 and 3-4, a method 600 for evaluating backlash of a ball screw assembly 1 and/or a device utilizing such a ball screw assembly 1 (e.g., a CNC machine, and/or the like, without limit), further to those descriptions, above is shown.

In a step 610, the ball screw assembly 1 may be equipped with one or more acceleration and/or vibration sensors 74, 76 affixed to, embedded within, and/or directed at (e.g., in the case of acoustic/laser sensors) at least one of the ball screw nut 40 and/or the carriage 60 for monitoring acceleration and/or vibration of the same. Additionally, the ball screw assembly 1 may be equipped with one or more motor sensors 78, if the motor 10 is not already provided with such sensors for operational purposes (e.g., stepper motors typically already include these sorts of encoders given the manner in which a stepper motor typically operates, so an additional sensor is not strictly necessary in such instances), for monitoring the speed, torque, and/or current draw of the motor 10.

In a step 620, the vibration data and the motor data is monitored during transient operations, such as when the ball screw assembly 1 is accelerating or decelerating.

In a step 630, and further to the above descriptions, the axial natural frequency of the ball screw assembly 1 may be determined based at least in part on the vibration data and/or the motor data.

In some aspects, the backlash of the ball screw assembly 1 may be empirically and/or theoretically correlated with the axial natural frequency, such as via a function, lookup table, or the like. In such instances, the current backlash of the ball screw assembly 1 may be calculated from the determined axial natural frequency. Accordingly, in an optional step 640, control of the ball screw assembly 1 via controller 80 may be influenced by the determined backlash. For example, the ball screw assembly 1 may be operated with knowledge that a certain backlash exists, and so tooling paths, patterns, and/or the like may be updated, corrected, offset, and/or the like, or otherwise changed (e.g., to adopt unidirectional approaches or the like) to account for this certain backlash, reducing the amount of error or inaccuracy that would otherwise be caused thereby.

In either case, in a step 650, the axial natural frequency and/or some derivative or product thereof may be compared against one or more predetermined thresholds. Further to the above, the predetermined threshold may correspond to the triggering of corrective control schemes, may correspond to the triggering of a warning issued to an operator in a step 660, may correspond to the halting of the ball screw assembly 1 or machine containing the same in a step 670, and/or the like, without limit.

In some aspects, the method 600 may optionally include steps relating to calibrating the ball screw assembly 1 and/or for generating those correlations referenced above. These steps may include providing the ball screw assembly 1 with one or more positional sensors 72, such as a positional sensor 72 embodied as a capacitive sensor; operating the ball screw assembly 1 to repeatedly move the ball screw nut 40 between positive and negative bounds; collecting data from any of the positional sensors 72, any vibrational sensors 74, 76, and the motor sensors 78—depending on what information is or is not already available; calculating the axial natural frequency of the ball screw assembly 1 over time; obtaining fit curves for the resulting data; and determining those predetermined thresholds further to the above for triggering responsive action. These calibrations and/or the generation of correlations may be started and/or finished at any point in the life cycle of a given ball screw assembly 1, encompassing all or some portion thereof of a total operational life of the given ball screw assembly.

It should now be understood that aspects of the present disclosure are directed to a ball screw assembly and methods for identifying degradation of the same that includes monitoring speed and/or torque characteristics of a motor that drives a ball screw to rotate, monitoring vibrational characteristics of a ball screw nut during operation, determining an axial natural frequency of the ball screw assembly 1, and evaluating the decrease in axial natural frequency over time to determine degradation of the preload of the ball screw assembly.

It is noted that recitations herein of a component of the present disclosure being “configured” in a particular way, to embody a particular property, or to function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While several aspects have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the aspects described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific aspects described herein. It is, therefore, to be understood that the foregoing aspects are presented by way of example only and that, within the scope of the appended claims and equivalents thereto, aspects may be practiced otherwise than as specifically described and claimed. Aspects of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one aspect, to A only (optionally including elements other than B); in another aspect, to B only (optionally including elements other than A); in yet another aspect, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one aspect, to at least one, optionally including more than one, A, with no B present (and optionally including elements other than B); in another aspect, to at least one, optionally including more than one, B, with no A present (and optionally including elements other than A); in yet another aspect, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It is to be understood that the aspects are not limited in its application to the details of construction and the arrangement of components set forth in the description or illustrated in the drawings. The invention is capable of other aspects and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several aspects of the invention has been presented for purposes of illustration. It is not intended to be exhaustive or to limit the invention to the precise structure, steps, and/or forms disclosed, and obviously many modifications and variations are possible in light of the above teaching.

1. A ball screw assembly comprising:
a ball screw operatively coupled to a motor;
a ball screw nut mounted on the ball screw, such that rotation of the ball screw about an axis of rotation causes the ball screw nut to translate longitudinally along the axis of rotation;
a vibration sensor configured to measure vibration of the ball screw nut; and
a motor sensor configured to measure at least one of a motor speed, a motor torque, and/or a motor current draw of the motor.

2. The ball screw assembly of claim 1, wherein the vibration sensor is attached to or provided in the ball screw nut.

3. The ball screw assembly of claim 1, further comprising a carriage coupled to the ball screw nut, wherein translation of the ball screw nut longitudinally along the axis of rotation of the ball screw also causes the carriage to be translated longitudinally along the axis of rotation.

4. The ball screw assembly of claim 3, wherein the vibration sensor is attached to or provided in the carriage.

5. The ball screw assembly of claim 3, further comprising a working tool attached to the carriage.

6. The ball screw assembly of claim 1, further comprising a controller that is communicatively coupled to the motor, the motor sensor, and the vibration sensor.

7. The ball screw assembly of claim 6, wherein the controller is configured to:
receive vibration data measured by the vibration sensor;
receive motor data measured by the motor sensor; and
determine an instantaneous axial natural frequency of the ball screw assembly based on the vibration data and the motor data.

8. The ball screw assembly of claim 7, wherein the controller is further configured to:
compare the instantaneous axial natural frequency of the ball screw assembly against a predetermined threshold; and
perform an action when the instantaneous axial natural frequency meets or crosses the predetermined threshold, the action comprising at least one of emitting a warning and halting the ball screw assembly.

9. The ball screw assembly of claim 7, wherein the controller is further configured to determine the instantaneous axial natural frequency of the ball screw assembly at multiple points in time across an operational life of the ball screw assembly.

10. The ball screw assembly of claim 9, wherein the controller is further configured to:
compare a rate of change of the instantaneous axial natural frequency of the ball screw assembly against a predetermined threshold; and
perform an action when the rate of change meets or crosses the predetermined threshold, the action comprising at least one of emitting a warning and halting the ball screw assembly.

11. The ball screw assembly of claim 7, wherein the controller is further configured to:
determine a backlash value from the instantaneous axial natural frequency of the ball screw assembly; and
modify an operation of the ball screw assembly based on the backlash value.

12. The ball screw assembly of claim 11, wherein modifying the operation of the ball screw assembly comprises at least one of correcting a tool path of the ball screw assembly and adopting a direction-dependent toolpath strategy.

13. The ball screw assembly of claim 7, further comprising a positional sensor configured to measure a backlash value, wherein the controller is further configured to:
correlate the backlash value with the instantaneous axial natural frequency of the ball screw assembly; and
export the correlation for use in a second ball screw assembly.

14. The ball screw assembly of claim 13, wherein the second ball screw assembly does not have a positional sensor configured to measure backlash.

15. A method for controlling a ball screw assembly comprising a ball screw that is operatively coupled to a motor, the method comprising:
receiving vibration data measured by a vibration sensor;
receiving motor data measured by a motor sensor; and
determining an instantaneous axial natural frequency of the ball screw assembly based on the vibration data and the motor data, wherein:
the vibration sensor is configured to measure vibration of a ball screw nut mounted to the ball screw; and
the motor sensor is configured to measure at least one of a motor speed, a motor torque, and/or a motor current draw of the motor.

16. The method of claim 15, further comprising:
comparing the instantaneous axial natural frequency of the ball screw assembly against a predetermined threshold; and
performing an action when the instantaneous axial natural frequency meets or crosses the predetermined threshold, the action comprising at least one of emitting a warning and halting the ball screw assembly.

17. The method of claim 15, further comprising:
determining the instantaneous axial natural frequency of the ball screw assembly at multiple points in time across an operational life of the ball screw assembly;
comparing a rate of change of the instantaneous axial natural frequency of the ball screw assembly against a predetermined threshold; and
performing an action when the rate of change meets or crosses the predetermined threshold, the action comprising at least one of emitting a warning and halting the ball screw assembly.

18. The method of claim 15, further comprising:
determining a backlash value from the instantaneous axial natural frequency of the ball screw assembly; and
modifying an operation of the ball screw assembly based on the backlash value.

19. The method of claim 15, further comprising:
controlling the ball screw assembly to move the ball screw nut between a first position and a second position; and
determining a backlash value based on positional data measured by a positional sensor.

20. A controller comprising at least one processor and a non-transitory computer-readable storage medium containing instructions that, when executed by the at least one processor, cause the controller to carry out the method of claim 15.
